(19) United States
(12) Patent Application Publication
(10) Pub. No.: US 2013/0073576 A1
(43) Pub. Date: Mar. 21, 2013

(54) System and Protocol To Dynamically Query Sensor Data Collections

(71) Applicants: David J. Lillethun, Dunwoody, GA (US); Ajay Mohindra, Hawthorne, NY (US); Anca Sailer, Hawthorne, NY (US)

(72) Inventors: David J. Lillethun, Dunwoody, GA (US); Ajay Mohindra, Hawthorne, NY (US); Anca Sailer, Hawthorne, NY (US)

(73) Assignee: International Business Machines Corporation, Armonk, NY (US)

(21) Appl. No.: 13/236,497

(22) Filed: Sep. 19, 2011

(51) Int. Cl. G06F 17/30

(52) U.S. Cl. 707/758; 707/E17.014

(57) ABSTRACT

A sensor registry includes a query dispatcher, a registration dispatcher, and a continuous query engine. The query dispatcher receives a query from a subscriber, searches a sensor database for at least one sensor that satisfies the query, and returns a result set corresponding to the query to the subscriber. The result set includes the at least one sensor. The registration dispatcher receives a message from a requesting sensor in a sensor network, and updates the sensor database based on the message. The continuous query engine receives the query from the query dispatcher, updates the result set corresponding to the query based on the received message, and notifies the subscriber upon determining that a change has been made to the result set.

### BACKGROUND

1. Technical Field

The present disclosure relates to dynamically querying sensor data collections, and more particularly, to a system and protocol for dynamically querying sensor data collections.

2. Discussion of Related Art

Intelligent applications that have the ability to sense their surroundings can be used to inform and enable administrators, experts (e.g., transportation and utility provisioning experts), first responders, law enforcement, and citizens to better manage and live in an area. For example, in a large city, intelligent applications can utilize metropolitan-scale sensor networks and large-scale computational resources (e.g., compute clouds) to improve living conditions in the city. In order to connect a running application, such as an application running in the cloud, to sensors in an area, the application must first discover the sensors available to it and obtain a subset of those sensors needed to complete a certain task.

For example, consider a transportation application whose goal is to help citizens make real-time decisions regarding the best means to travel to a point in the city from their current location. A citizen may have a number of travel options including, for example, driving a car, riding a bicycle, taking a train, or taking a bus. The transportation application may have access to static data such as, for example, maps of the city, and timetables and route information for trains and buses. However, in order to make real-time decisions based on up-to-date conditions, the transportation application needs access to live sensor data which can be used to determine traffic conditions caused by, for example, congestion, construction, and accidents, as well as actual train and bus schedules (e.g., whether trains and buses are on-time or running late).

To aid the transportation application, a city may include a large number of sensors including, for example, traffic sensors, GPS radios located on trains and buses, cameras, weather and atmospheric sensors, and power and water utility sensors. The transportation application utilizes a subset of the total available sensor types that are applicable to transportation evaluation. For example, a car-based transportation application may choose to use only traffic sensors. Further, the transportation application utilizes a subset of the subset of applicable sensor types that are on routes from a citizen's current location to the destination location. In addition, certain phenomena may be detectable by more than a single type of senor. For example, traffic congestion may be detected by sensors that measure the number of cars per minute that pass the sensor, or by traffic cameras that monitor the roads using a computer vision algorithm. Further, certain parts of the city may only have one type of sensor, or a limited number of different types of sensors, installed.

### BRIEF SUMMARY

According to an exemplary embodiment, a sensor registry includes a query dispatcher, a registration dispatcher, and a continuous query engine. The query dispatcher is configured to receive a query from a subscriber, search a sensor database for at least one sensor that satisfies the query, and return a result set corresponding to the query to the subscriber, wherein the result set includes the at least one sensor. The registration dispatcher is configured to receive a message from a requesting sensor in a sensor network, and update the sensor database based on the message. The continuous query engine is configured to receive the query from the query dispatcher, update the result set corresponding to the query based on the received message, and notify the subscriber upon determining that a change has been made to the result set.

A method of querying sensors in a sensor network includes receiving a query from a subscriber, searching a sensor database for at least one sensor that satisfies the query, returning a result set including the at least one sensor to the subscriber, and notifying the subscriber upon determining that a change has been made to the result set.

### BRIEF DESCRIPTION OF THE SEVERAL VIEWS OF THE DRAWINGS

The above and other features of the present disclosure will become more apparent by describing in detail exemplary embodiments thereof with reference to the accompanying drawings, in which:

FIG. 1 shows a sensor registry according to an exemplary embodiment of the present disclosure.

FIG. 2 is a flowchart showing functions performed by a query dispatcher in a sensor registry according to an exemplary embodiment of the present disclosure.

FIG. 3 is a flowchart showing functions performed by a registration dispatcher in a sensor registry according to an exemplary embodiment of the present disclosure.

FIG. 4 is a flowchart showing functions performed by a continuous query engine in a sensor registry according to an exemplary embodiment of the present disclosure.

FIG. 5 is a flowchart showing functions performed by a value query engine in a sensor registry according to an exemplary embodiment of the present disclosure.

FIG. 6 is a computer system for implementing a method of dynamically querying sensor data collections according to an exemplary embodiment of the present disclosure.

### DETAILED DESCRIPTION

According to exemplary embodiments of the present disclosure, a sensor registry allows applications to use queries to locate sensors needed by the applications. The sensor registry provides the applications with information regarding the sensors, allowing the applications to make decisions in regards to which sensors to use.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Exemplary embodiments of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

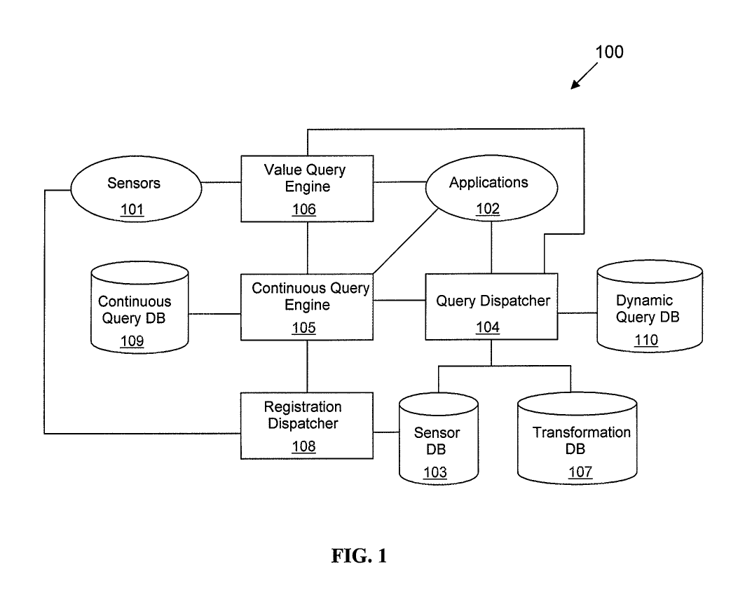

FIG. 1 shows a sensor registry 100 according to an exemplary embodiment.

A sensor network includes a plurality of sensors 101 disposed within an area, for example, within a city. The plurality of sensors 101 may include various types of sensors. In an exemplary embodiment, the sensor network is dynamic, and the sensor registry 100 is configured to interface with the dynamic sensor network. For example, the sensor registry 100 handles dynamic changes when they occur, such as, for example, allowing new sensors to register themselves in the sensor registry 100 when they are added to the sensor network, and allowing sensors to go offline when they are not functioning. When changes are made in the sensor registry 100, the sensor registry 100 notifies applications 102 of changes to the result sets of queries that were previously made. Thus, queries made by an application are continuous rather than instantaneous, as they continue monitoring sensors that match the query for the life of the application. In addition, the applications 102 themselves are also dynamic. For example, queries made by an application may change as the application runs. These dynamic queries are handled by the sensor registry 100. In addition to performing dynamic queries, applications 102 may also perform nested queries and intentional queries. Applications may run on various devices including, for example, a desktop computer or a handheld device such as a smartphone. Applications may also run in the cloud and devices may access the applications via an Internet connection such as, for example, a Wi-Fi connection, a Third Generation (3G) cellular connection including, for example, an Evolved High-Speed Packet Access (HSPA+) connection, or a Fourth Generation (4G) cellular connection including, for example, a Long Term Evolution (LTE) connection or a Worldwide Interoperability for Microwave Access (WiMax) connection.

In FIG. 1, a sensor database 103 stores sensor metadata corresponding to the sensors 101 in an area (e.g., a city). A query dispatcher 104 handles all application requests, checks queries against sensor metadata stored in the sensor database 103, dispatches queries to a continuous query engine 105 and a value query engine 106 when necessary, and handles dynamic and nested queries. Application requests may include, for example, new queries, query updates that are used for dynamic queries, and end query requests to stop a currently running continuous query. When implementing continuous nested queries, the query dispatcher 104 may receive notifications from the continuous query engine 105 or the value query engine 106. These notifications are treated similarly to dynamic query updates.

Nested queries use the results of one query to form another query. For example, a goal of a surveillance application may be to discover all of the cameras in an area that are equipped with motion sensors. An inner query (e.g., a subquery) may first find the locations of all motion sensors in the area. The results of the inner query may then be used to form an outer query that discovers all cameras in the area that have the same locations as the motion sensors. In another example, a goal of a surveillance application may be to discover all of the cameras in an area that have detected motion, in order to avoid unnecessarily monitoring video in areas where there is no motion (e.g., empty hallways or alleys). In this case, in addition to considering metadata of motion sensors, a nested query reads data from the sensor streams indicated in the nested query and considers the actual value of the motion sensors. In this example, the nested query is a continuous query, since the values of the sensor streams changes over time.

Intentional queries involve receiving data from a sensor and transforming the data into a different type of information or format by applying a series of processes. This series of processes is referred to as a transformation. For example, in addition to issuing multiple queries (e.g., a first query to discover car flow sensors and a second query to discover video cameras), an application can make a single intentional query for a specified task (e.g., determining traffic congestion), and receive a result set of sensors that satisfy the specified task. The specified task may be provided directly or indirectly by applying a transformation.

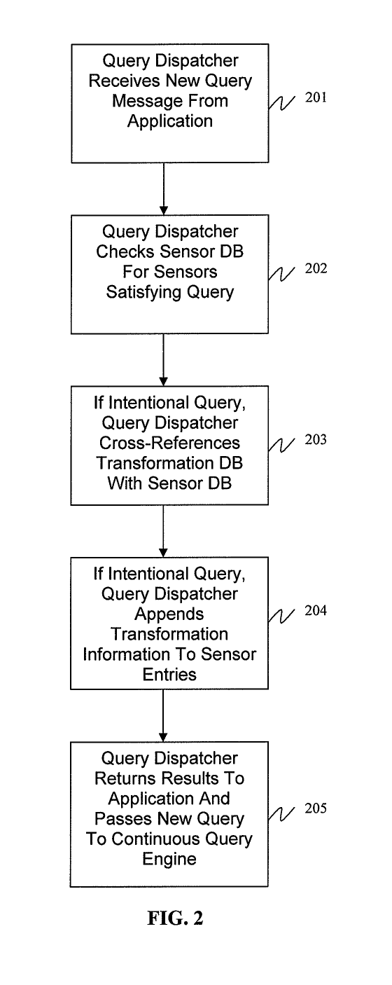

FIG. 2 is a flowchart showing functions performed by the query dispatcher 104 in the sensor registry 100 according to an exemplary embodiment.

Referring to FIGS. 1 and 2, when the query dispatcher 104 receives a new query message from an application (block 201), the query dispatcher 104 first checks the sensor database 103 for sensors that satisfy the query (block 202). When the query message is an intentional query, the query dispatcher 104 cross-references a transformation database 107 with the sensor database 103 to search for additional sensors that satisfy the intentional query (block 203). Transformation information is appended to the sensor entries in the result set that corresponds to sensors that satisfy the intentional query (block 204). The results are then returned to the application and the new query is passed to the continuous query engine 105 to monitor for any changes that may be made to the result set (block 205).

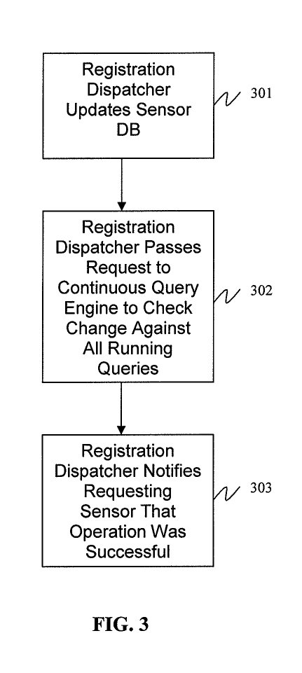

FIG. 3 is a flowchart showing functions performed by a registration dispatcher 108 in the sensor registry 100 according to an exemplary embodiment.

Referring to FIGS. 1 and 3, the registration dispatcher 108 serves as an interface between sensors 101 and the sensor registry 100 by allowing the sensors 101 to send messages to the registration dispatcher 108. For example, sensors 101 may send a registration request to the registration dispatcher 108 to register themselves in the sensor registry 100, a removal request to remove themselves from the sensor registry 100, or a metadata update request to update their metadata in the sensor registry 100. These functions are performed by updating the sensor database 103 (block 301), passing a request to the continuous query engine 105 requesting that the change be checked against all running queries (block 302), and notifying the requesting sensor that the operation was successful (block 303).

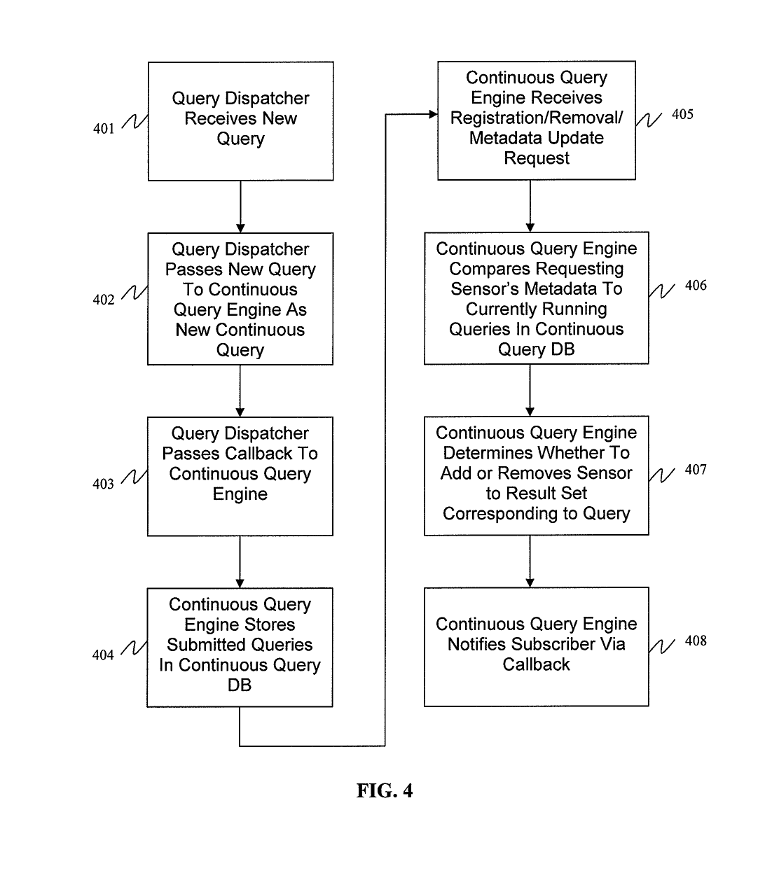

FIG. 4 is a flowchart showing functions performed by the continuous query engine 105 in the sensor registry 100 according to an exemplary embodiment.

Referring to FIGS. 1 and 4, the continuous query engine 105 monitors all queries on an ongoing basis to determine when any changes made to a sensor's metadata alters the results of a query. When the results of a query are altered, the continuous query engine 105 notifies the subscriber (e.g., an application). In an exemplary embodiment, the continuous query engine 105 may handle three types of events: (1) new continuous queries, (2) updates to existing continuous queries, and (3) registering, removing, or updating requests. When the query dispatcher 104 receives a new query (block 401), it passes the query to the continuous query engine 105 as a new continuous query (block 402). The query dispatcher 104 also passes a callback to the continuous query engine 105 (block 403) with each query passed to the continuous query engine 105. The callback is used to notify the subscriber when changes to the query's results occur. The subscriber may be an application that submitted the query, the query dispatcher 104 when the submitted query is a nested query, or the value query engine 106 when the submitted query is a continuous query. The continuous query engine 105 stores all of the queries submitted to it in a continuous query database 109 (block 404) until the continuous query engine 105 receives a registration request, removal request, or metadata update request (block 405). Once the continuous query engine 105 receives a registration request, removal request, or metadata update request from the registration dispatcher 108, the continuous query engine 105 compares the requesting sensor's metadata to all currently running queries in the continuous query database 109 (block 406). When a match is found, the continuous query engine 105 determines whether the sensor should be added or removed from the result set corresponding to the query (block 407). For example, the sensor is added to the result set when the request is a registration request, the sensor is removed from the result set when the request is a removal request, and the sensor is updated in the result set when the request is a metadata update request. The continuous query engine 105 then notifies the subscriber via the associated callback (408).

A value-based query may include a portion corresponding to actual sensor values and another portion corresponding to sensor metadata. The portion corresponding to actual sensor values is evaluated by the value query engine 106, and the portion corresponding to sensor metadata is handled by the query dispatcher 104 and the continuous query engine 105. In an exemplary embodiment, the value query engine 106 may handle three types of events: (1) new value queries, (2) updates to value queries received from the query dispatcher 104 or the continuous query engine 105, and (3) changes in the sensor values being monitored.

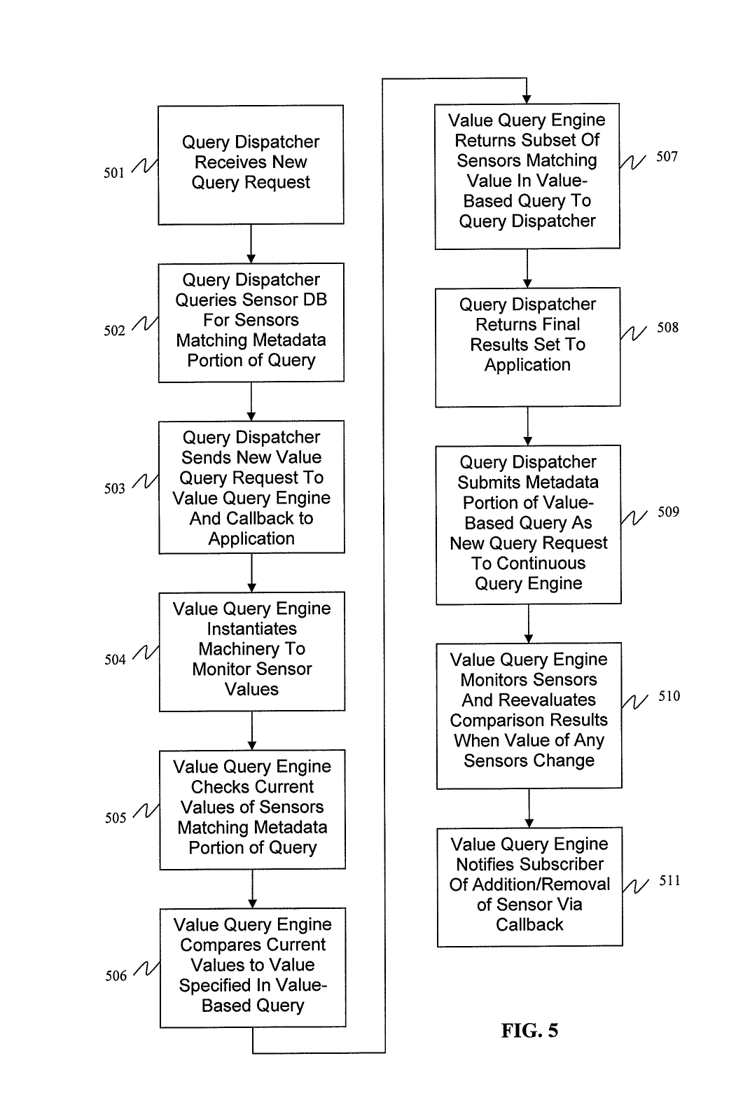

FIG. 5 is a flowchart showing functions performed by the value query engine 106 in the sensor registry 100 according to an exemplary embodiment.

Referring to FIGS. 1 and 5, when the query dispatcher 104 receives a new query request from an application for a value-based query (block 501), the query dispatcher 104 queries the sensor database 103 to find all sensors matching the metadata portion of the query (block 502). The resulting list of sensors is a preliminary result set. The query dispatcher 104 then sends a new value query request to the value query engine 106, and a callback to the application (block 503). The value query engine 106 instantiates machinery to monitor the sensor values of the sensors in the preliminary result set (block 504). The value query engine 106 checks the current values of the sensors in the preliminary result set (block 505), compares the current values to the value specified in the value-based query (block 506), and returns a subset of sensors matching the value in the value-based query to the query dispatcher 104 (block 507). The query dispatcher 104 then returns the final results set to the application (block 508).

The query dispatcher 104 further submits the metadata portion of the value-based query as a new query request to the continuous query engine 105 (block 509). In this case, the subscriber to the continuous query is the value query engine 106 rather than an application, and the callback is treated by the value query engine 106 as a query update request. The value query engine 106 continuously monitors the entire set of sensors and reevaluates the comparison results of the sensor values and the value-based query each time a value of any of the sensors changes (block 510). If the evaluation results in a sensor that previously did not satisfy the value-based query now satisfying the value-based query, or results in a sensor that previously satisfied the value-based query now not satisfying the value-based query, the value query engine 106 notifies the subscriber of the addition or removal of the sensor via the callback (block 511).

The continuous query engine 105 and the value query engine 106 work together to continuously monitor queries. For example, when the value query engine 106 receives an update request, the value query engine 106 updates the set of sensors that it is monitoring. If the update request is a delete request, and the sensor the delete request refers to is included in the result set (e.g., the sensor's value had most recently passed the comparison check), the value query engine 106 passes the delete request via the query's subscribed callback. If the update request is an add request, the value query engine 106 checks the sensor's current value and passes the add request via the callback if the sensor's value passes the check. The value query engine 106 then continues monitoring the updated set of sensors for changes in their values.

When the query dispatcher 104 receives a new query request for a dynamic query, the query dispatcher 104 stores the dynamic query metadata in a dynamic query database 110. The query dispatcher 104 may initially handle the dynamic query in the same manner that it handles a static query. For example, the initial values provided by the application may be used as the dynamic parameters in the query. In order to update the dynamic query, the application sends the query dispatcher 104 a dynamic query update message that includes new values for the dynamic parameters. The query dispatcher 104 uses the dynamic query metadata from the dynamic query database 110 to perform the query using the new values. Performing the queries includes updating the query in the continuous query engine 105, and updating the value query engine 106 if the query is value-based dynamic query. New dynamic queries provided to the continuous query engine 105 are provided as fully instantiated queries (e.g., the parameters are complete). When the continuous query engine 105 receives an update message from an application, the update message may include the new query to monitor, and the continuous query engine 105 substitutes the old query with the new query. Updates do not change the subscriber's callback.

Nested queries include at least one inner query and at least one outer query. The outer queries are treated in a similar manner as dynamic queries. For example, the results of the inner query are treated by the nested query as a dynamic parameter. The query dispatcher 104 submits itself as the subscriber for all inner queries submitted to the continuous query engine 105 and the value query engine 106. As a result, updates made to dynamic parameters in a nested query are based on the results of the inner query when the query dispatcher's 104 callback is called. Nested queries may include multiple levels of nesting, and return the results of the outermost query to the appropriate application upon termination.

Sensor metadata is structured to facilitate machine understanding between the sensor metadata, query results, and application code. Sensor metadata is used to describe each sensor and its capabilities, and thus, indicate the differences between different sensors. Sensor metadata is extensible to accommodate the wide variety of present and future sensor devices that may be added to the sensor network.

In an exemplary embodiment, sensor metadata is represented as a set of properties, and each property is a key-value pair. Values may contain data of any data type. Keys may be any string label that does not include a line break or several other reserved characters, however, in an exemplary embodiment, line breaks and/or reserved characters may be added using escape sequences. Certain key labels may be reserved for specific properties and representations. For example, in an exemplary embodiment, the key label value represents the current sensor data value. The key label id is a property automatically populated by the sensor registry that corresponds to a locally unique identifier for the sensor. The key label connection data, which is provided by each sensor that registers itself, indicates to the application how the respective sensor is connected to and how the respective sensor's data value is read. The key label connection type, which is provided by each sensor that registers itself, indicates to the application what method to use to connect to the respective sensor (e.g., how the application should interpret the connection data property). Standards may be used to define specific key labels to be used to represent certain properties, and how the values of those properties are represented. Such standards allow sensors to provide the properties that applications are expecting to be provided, and allow applications to properly interpret the sensor properties observed by the applications. However, other than reserved key labels (e.g., value, id, connection data, connection type), such standards are not required, and properties may be defined using any key label, resulting in an extensible system.

A sensor metadata query language is used by applications to query the sensors registered in the system. The sensor metadata query language includes certain features similar to those in the Structured Query Language (SQL). The sensor metadata query language is different from the API used to allow sensors to register, remove, and update their metadata in the sensor registry. The sensor metadata query language provides a layer of abstraction between the registry interface and the internal databases used by the registry (e.g., a user may utilize the sensor metadata query language without having particular knowledge of the structure of the internal databases), and may be programmatically converted to other standard query languages, which allows for the utilization of standardized query optimizers (e.g., optimizers used in commercial database engines). Queries using the sensor metadata query language begin with the keyword SELECT. Query example (1) shows a basic query:
(1) SELECT id, connection type, connection data FROM Sensors WHERE type=‘camera’
   In query example (1), id, connection type, and connection data are the keys of the properties to be retrieved. For example, the query result corresponding to this query will include the values of these properties for all sensors in the result set. The expression FROM Sensors may be included to improve the readability of queries written using the sensor metadata query language, however, this expression may be omitted in exemplary embodiments. The WHERE clause corresponds to the portion of the query that includes the properties of the sensors that are being searched for. For example, the WHERE clause may include the terms KEY, COMP and LIT, where KEY is a property key, COMP is a comparison operator, and LIT is a literal that the property's value will be compared against using COMP. Omission of the WHERE clause returns all registered sensors in the sensor registry. A query may also begin with the SELECT * expression, which returns all properties that the sensors have.

Query example (1) returns sensors whose type property has a value matching “camera”. Any sensors that do not have a type property are not returned. A semicolon may be used to end a query expression, but is not required. Comparison operators may include, but are not limited to, the comparison operators shown in Table 1:

TABLE 1

| | |
|---|---|
| = | equal to |
| <> | is not equal to |
| > | greater than |
| < | less than |
| >= | greater than or equal to |
| <= | less than or equal to |
| BETWEEN | is between |
| IN | is in WHERE clause |

The sensor metadata query language includes a MATCHES operation that matches against a regular expression. The query language also supports compound comparisons using, for example, AND and OR operators, and supports the use of parentheses to determine the order of the AND and OR operations. As a result, queries similar to the one shown in query example (2) may be utilized:
(2) SELECT * FROM Sensors WHERE prop1>val1 AND (prop2=val2 OR prop3<>val3)

Query example (3) shows a dynamic query implemented using the sensor metadata query language:
(3) SELECT * FROM Sensors WHERE prop1=$1 AND prop2 IN ($2)
   In query example (3), $1 and $2 are replaceable parameters. Replaceable parameters allow different values to be specified by an application. As a result, the system may partially filter data in advance for a set of related queries. For example, to update a query, an application supplies new values corresponding to the replaceable parameters in the query. A change list including the sensors to be added and/or removed from the previous query result is then generated.

Query example (4) shows a value-based query implemented using the sensor metadata query language:
(4) SELECT * FROM Sensors WHERE type=‘motion detector’ WITH value=true
   Value-based queries allow an application to request sensors whose values meet a specified criteria. For example, the query in query example (4) requests only motion detectors that are currently detecting motion. Since value-based queries compare the value of a sensor to a literal using a comparison operator, value-based queries are utilized to query sensors whose value is a simple data type.

Query examples (5) and (6) show nested queries implemented using the sensor metadata query language:
(5) SELECT * FROM Sensors WHERE type=‘camera’ AND location IN (SELECT location FROM Sensors WHERE type=‘motion detector’)
(6) SELECT * FROM Sensors WHERE type=‘camera’ AND location=(SELECT location FROM Sensors WHERE id=1001)
   As shown in query examples (5) and (6), the nested query is placed in parenthesis within the outer query. In a nested query, the SELECT clause of the inner query specifies a single property to be returned. The specified single property may be returned for multiple sensors, as shown in query example (5), or a single sensor, as shown in query example (6). In query example (5), a list corresponding to the multiple sensors is generated.

Nested queries may include value-based queries, as shown below in query examples (7), (8) and (9). The value being searched for may be located in the inner query. As a result, queries such as the one shown in query example (7) may be executed:
(7) SELECT * FROM Sensors WHERE type=‘camera’ AND location IN (SELECT location FROM Sensors WHERE type=‘motion detector’ WITH value=true)
   In query example (7), all cameras present in locations where motion has been detected are returned. The value being searched for may also be located in the outer query, and may be compared to a literal provided in the inner query. As a result, queries such as the one shown in query example (8) may be executed:
(8) SELECT * FROM Sensors WHERE type=‘GPS’ AND tracking=‘bus’ WITH value IN (SELECT location FROM Sensors WHERE type=‘camera’)
   In query example (8), all sensors that are tracking buses located where there are cameras are returned. The value being searched for may be located in the inner query, and the values from the sensors in the inner query may be returned instead of a property. These values may then be used as literals in the outer query. As a result, queries such as the one shown in query example (9) may be executed:
(9) SELECT * FROM Sensors WHERE type=‘camera’ AND location IN (SELECT value FROM Sensors WHERE type=‘GPS’ AND tracking=‘bus’)
   In query example (9), cameras that are located where there are buses are returned. In nested value-based queries, the outermost query returns properties to the querying application.

The flowcharts and block diagrams in the figures illustrate the architecture, functionality, and operation of possible implementations of systems, methods and computer program products according to various exemplary embodiments of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

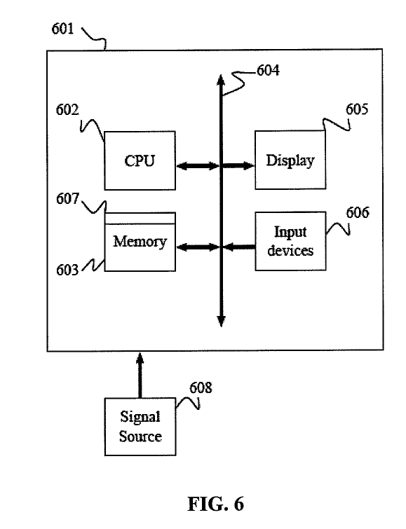

More particularly, referring to FIG. 6, according to an exemplary embodiment of the present disclosure, a computer system 601 for dynamically querying sensor data collections can comprise, inter alia, a central processing unit (CPU) 602, a memory 603 and an input/output (I/O) interface 604. The computer system 601 is generally coupled through the I/O interface 604 to a display 605 and various input devices 606 such as a mouse and keyboard. The support circuits can include circuits such as cache, power supplies, clock circuits, and a communications bus. The memory 603 can include random access memory (RAM), read only memory (ROM), disk drive, tape drive, etc., or a combination thereof. Exemplary embodiments of present disclosure may be implemented as a routine 607 stored in memory 603 (e.g., a non-transitory computer-readable storage medium) and executed by the CPU 602 to process the signal from the signal source 608. As such, the computer system 601 is a general-purpose computer system that becomes a specific purpose computer system when executing the routine 607 of the present disclosure.

The computer platform 601 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

Having described exemplary embodiments for a system and protocol for dynamically querying sensor data collections, it is noted that modifications and variations can be made by persons skilled in the art in light of the above teachings. It is therefore to be understood that changes may be made in exemplary embodiments of the disclosure, which are within the scope and spirit of the disclosure as defined by the appended claims. Having thus described exemplary embodiments of the disclosure with the details and particularity required by the patent laws, what is claimed and desired protected by Letters Patent is set forth in the appended claims.

What is claimed is:

1. A sensor registry, comprising:
a query dispatcher configured to receive a query from a subscriber, search a sensor database for at least one sensor in a sensor network that satisfies the query, and return a result set corresponding to the query to the subscriber, wherein the result set includes the at least one sensor;
a registration dispatcher configured to receive an update request from a requesting sensor in the sensor network, and update the sensor database based on the update request; and
a continuous query engine configured to receive the query from the query dispatcher, update the result set corresponding to the query based on the update request, and notify the subscriber upon determining that a change has been made to the result set.

2. The sensor registry of claim 1, wherein the update request is one of a registration request, a removal request, or a metadata update request.

3. The sensor registry of claim 2, wherein the registration dispatcher is configured to add the requesting sensor to the sensor database upon receiving the registration request, remove the requesting sensor from the sensor database upon receiving the removal request, and update metadata of the requesting sensor in the sensor database upon receiving the metadata update request.

4. The sensor registry of claim 1, further comprising:
a continuous query database configured to store continuous queries, wherein the continuous query engine is configured to store the query in the continuous query database as one of the continuous queries.

5. The sensor registry of claim 4, wherein the continuous query engine is configured to update a result set corresponding to one of the continuous queries stored in the continuous query database based on the update request.

6. The sensor registry of claim 5, wherein the result set corresponding to the one of the continuous queries is updated based on a comparison of metadata of the requesting sensor and the one of the continuous queries.

7. The sensor registry of claim 6, wherein the continuous query engine is configured to add the requesting sensor to the result set corresponding to the one of the continuous queries upon determining that the requesting sensor satisfies the one of the continuous queries and is not included in the one of the continuous queries,
remove the requesting sensor from the result set corresponding to the one of the continuous queries upon determining that the requesting sensor does not satisfy the one of the continuous queries and is not included in the one of the continuous queries, and
update the result set corresponding to the one of the continuous queries upon determining that the requesting sensor satisfies the one of the continuous queries, the metadata of the requesting sensor has changed, and the requesting sensor is included in the one of the continuous queries.

8. The sensor registry of claim 1, further comprising:
a value query engine configured to receive a sensor value portion of the query from the query dispatcher,
wherein the query includes the sensor value portion and a sensor metadata portion, the query dispatcher is configured to generate a preliminary result set including every sensor in the sensor database matching the sensor metadata portion of the query, and the value query engine is configured to generate a final result set including sensors in the preliminary result set having a value matching the value portion of the query.

9. The sensor registry of claim 1, further comprising:
a dynamic query database configured to store dynamic queries,
wherein the query dispatcher is configured to receive a dynamic query update message including a new sensor value from the subscriber, and update one of the stored queries corresponding to the dynamic query update message based on the new sensor value.

10. The sensor registry of claim 1, wherein the query dispatcher is configured to receive a callback from the subscriber with the query, and the continuous query engine is configured to receive the callback from the query dispatcher and notify the subscriber via the callback.

11. The sensor registry of claim 1, wherein the query is a nested query including an
inner query and an outer query, and the outer query is generated based on results of the inner query.

12. The sensor registry of claim 1, further comprising a transformation database,
wherein the query is an intentional query, and the query dispatcher is configured to cross-reference the transformation database with the sensor database to search for sensors that satisfy the intentional query.

13. The sensor registry of claim 12, wherein transformation information is appended to sensor entries in the result set that correspond to the sensors that satisfy the intentional query.

14. The sensor registry of claim 1, wherein the query is a dynamic query including a replaceable parameter, and the subscriber updates the query by supplying a new value corresponding to the replaceable parameter.

15. The sensor registry of claim 1, wherein the subscriber is an application.

16. A method of querying sensors in a sensor network, comprising:
receiving a query from a subscriber;
searching a sensor database for at least one sensor that satisfies the query;
returning a result set including the at least one sensor to the subscriber; and
notifying the subscriber upon determining that a change has been made to the result set.

17. The method of claim 16, further comprising:
receiving an update request from a requesting sensor in the sensor network; and
updating the sensor database based on the update request.

18. The method of claim 17, further comprising:
adding the requesting sensor to the sensor database upon determining that the update request is a registration request;
removing the requesting sensor from the sensor database upon determining that the update request is a removal request; and
updating metadata of the requesting sensor in the sensor database upon determining that the update request is a metadata update request,
wherein the update request is one of the registration request, the removal request, or the metadata update request.

19. The method of claim 17, further comprising:
storing the query as one of a plurality of continuous queries in a continuous query database;
monitoring the plurality of continuous queries; and
updating a result set corresponding to one of the continuous queries based on the update request.

20. The method of claim 19, further comprising:
adding the requesting sensor to the result set corresponding to the one of the continuous queries upon determining that the requesting sensor satisfies the one of the continuous queries and is not included in the one of the continuous queries;
removing the requesting sensor from the result set corresponding to the one of the continuous queries upon determining that the requesting sensor does not satisfy the one of the continuous queries and is not included in the one of the continuous queries; and
updating the result set corresponding to the one of the continuous queries upon determining that the requesting sensor satisfies the one of the continuous queries, metadata of the requesting sensor has changed, and the requesting sensor is included in the one of the continuous queries.

21. The method of claim 16, further comprising:
generating a preliminary result set including all sensors in the sensor database matching a sensor metadata portion of the query; and
generating a final result set including sensors in the preliminary result set having a value matching a value portion of the query,
wherein the query includes the sensor metadata portion and the value portion.

22. The method of claim 16, further comprising:
receiving a dynamic query update message including a new sensor value from the subscriber; and
updating a stored query corresponding to the dynamic query update message based on the new sensor value.

23. The method of claim 16, further comprising:
receiving a callback from the subscriber with the query; and
notifying the subscriber via the callback.

24. The method of claim 16, further comprising:
generating an outer query based on results of an inner query, wherein the query received from the subscriber includes the outer query and the inner query.

25. The method of claim 16, wherein the subscriber is an application.
